(19) United States
(12) Patent Application Publication
(10) Pub. No.: US 2024/0396075 A1
(43) Pub. Date: Nov. 28, 2024

(54) Pouch Sealing Method for Pouch-Type Secondary Battery and Main Sealing Tool Used in the Method

(71) Applicant: LG Energy Solution, Ltd., Seoul (KR)

(72) Inventors: Sujin Park, Daejeon (KR); Minjae Lee, Daejeon (KR); Ju Yeong Seol, Daejeon (KR); Jin Kyu Kim, Daejeon (KR); Heejune Yang, Daejeon (KR)

(73) Assignee: LG Energy Solution, Ltd., Seoul (KR)

(21) Appl. No.: 18/569,681

(22) PCT Filed: Oct. 5, 2022
(86) PCT No.: PCT/KR2022/015004

§ 371 Date: Dec. 13, 2023

(30) Foreign Application Priority Data
Oct. 6, 2021 (KR) 10-2021-0132371

(51) Int. Cl. H01M 10/04; H01M 50/105; H01M 50/55; H01M 50/553

(52) U.S. Cl. CPC H01M 10/049; H01M 10/0404; H01M 50/105; H01M 50/55; H01M 50/553

(57) ABSTRACT

A pouch sealing method for a pouch-type secondary battery includes performing degassing sealing of a pouch, performing a formation process, performing a degassing process, and performing a main sealing process. The method can ensure excellent sealing and insulating properties, while maximally reducing the ratio of dead space due to the sealing portion of the pouch-type secondary battery. A sealing tool used in the method is also disclosed.

### CROSS-REFERENCE TO RELATED APPLICATIONS

The present application is a national phase entry under 35 U.S.C. of No. § 371 International Application PCT/KR2022/015004 filed on Oct. 5, 2022 which claims the benefit of priority based on Korean Patent Application No. 10-2021-0132371, filed on Oct. 6, 2021, all contents of which are incorporated herein by reference.

### TECHNICAL FIELD

The present disclosure relates to a pouch sealing method for a pouch-type secondary battery and a main sealing tool used in this method.

### BACKGROUND ART

Lithium secondary batteries, which are attracting attention as a next-generation power source among rechargeable secondary batteries, have high energy density, no memory effect, a low degree of spontaneous discharge even when not in use, and very lightweight. Accordingly, the lithium secondary batteries are often used in portable electronic devices such as laptop computers, cameras, and mobile phones. In addition, due to high energy density, the lithium secondary batteries are increasingly used in the field of a defense industry, an automation system, an automobile and an aviation industry, and are widely commercially available for a motor drive source for electric vehicles and hybrid vehicles.

Such lithium secondary batteries can generally be classified into lithium ion batteries using a liquid electrolyte and lithium polymer batteries using a polymer electrolyte depending on the type of electrolytic solution. In addition, the secondary batteries are manufactured in various shapes, and can be broadly classified into cylindrical, prismatic, and pouch types.

In particular, the pouch-type lithium secondary battery case made of a pouch packaging material that is has a significantly lighter and more flexible than the aluminum case, and can have a higher energy density than the prismatic lithium secondary battery.

In the pouch-type lithium secondary battery, a sealing portion is formed at an edge of an exterior material to seal the pouch exterior material. Since the edge increases a dead space of the secondary battery and causes a decrease in the energy density per volume, a technology for increasing the energy density of the secondary battery by bending or folding the edge sealing portion is used.

In addition, a method for maximally reducing a proportion of the dead space due to the sealing portion formed at the edge compared to the exterior material having the same size by forming a sealing portion having a predetermined width as close to the electrode assembly as possible at the edge of the exterior material is also applied.

For example, Korean Patent Publication No. 10-0883919 discloses a technique of cutting out a corner in which left and right sealing portions and an upper sealing portion intersect to fold the sealing portions of the left and right edge and fold the sealing portion of the upper edge. However, when the corner in which the both sealing portions and the upper sealing portion intersect is cut out in this way, there is a problem that the sealing reliability of the exterior material deteriorates, and there may be a problem that the connection of a tab-lead coupling part inside the exterior material may be damaged or a short circuit occurs between the electrode assembly and the electrode tab, when bending the upper sealing portion along a bending line excessively nearer to the electrode assembly accommodated in the exterior material.

### DISCLOSURE

### Technical Problem

The present technology was devised to solve the above problems of the related art.

It is an object of the present disclosure to provide a pouch sealing method for a pouch-type secondary battery capable of ensuring excellent sealing and insulating properties, while maximally reducing the ratio of dead space due to the sealing portion of the pouch-type secondary battery, and a sealing tool used in the method.

### Technical Solution

In order to achieve the above object, an aspect of the present invention provides a pouch sealing method for a pouch-type secondary battery, the method including:
wherein the degassing sealing is formed such that a full-width sealing portion including an electrode terminal sealing portion, a horizontal sealing portion formed from an electrode terminal to a dead space distal end in a horizontal direction, and an inclined sealing portion in the direction opposite to the horizontal sealing portion, wherein the inclined sealing portion includes an inclined portion inclined toward an electrode assembly housing portion between the electrode terminal and a distal end, and
the main sealing includes a parallel sealing which is parallel to a full-length direction of the electrode assembly housing portion, and sealing for correcting the horizontal sealing portion of the full-width sealing portion to be symmetrical with the inclined sealing portion of the opposite direction.

In an aspect of the present invention, after the main sealing, an outer horizontal portion of the corrected portion may be symmetrically removed to the inclined sealing portion to form an inclined portion.

In an aspect of the present invention, an electrode terminal of the pouch-type secondary battery may be formed only in one direction or in two directions symmetrical to each other.

In an aspect of the invention, the degassing sealing may include sealing a distal end of the full-width direction of the dead space in a straight line to the full-length direction.

In an aspect of the present invention, the degassing sealing may include sealing a dead space distal end of the full-width direction of the electrode assembly housing portion in a straight line to the full-length direction; or does not include the sealing of the distal end, when the distal end of the full-width direction of the electrode assembly housing portion is in the state of being sealed by the pouch case structure.

Further, an aspect of the present invention provides a main sealing tool used for the main sealing, the main sealing tool including:
a linear pressing portion that performs a parallel
sealing parallel to a full-length direction of an electrode assembly housing portion; and an inclined pressing portion coupled to one end of the linear pressing portion with an internal angle in a range exceeding 90 degrees to 150 degrees,
wherein the inclined pressing portion performs a function of correcting the horizontal sealing portion of the full-width sealing portion to be symmetrical with an inclined sealing portion in an opposite direction.

In an aspect of the present invention, an inclined pressing portion may be further coupled to the other end of the linear pressing portion in the same direction and at the same internal angle with the inclined pressing portion.

In an aspect of the present invention, the inclined pressing portion may have a shape similar to a triangular prism or a quadrangular prism.

In an aspect of the invention, the main sealing tool may further include an extension through which the linear pressing portion extends from the inclined pressing portion.

### Advantageous Effects

The pouch sealing method for a pouch-type secondary battery in accordance with the present invention desirably provides excellent sealing and insulating properties, while minimizing the ratio of dead space of the sealing portion.

Also, the pouch sealing tool used in the above method preferably effectively reduces the ratio of dead space and provides excellent sealing and insulating properties to the pouch case.

### DESCRIPTION OF DRAWINGS

FIG. 1 is a photograph of the form of a pouch-type secondary battery with a reduced dead space.

FIG. 2 is a diagram schematically showing the form of degassing sealing performed in the process of manufacturing the pouch-type secondary battery having the form shown in FIG. 1.

FIG. 3 is a diagram showing the cause of deterioration of sealing and insulating properties caused by the degassing sealing of the form shown in FIG. 2.

FIG. 4 is a diagram showing an embodiment of the degassing sealing in the pouch sealing of the pouch-type secondary battery in an embodiment of the present invention.

FIGS. 5(a) and 5(b) are diagrams showing an embodiment of a main sealing in the pouch sealing of the pouch-type secondary battery in an embodiment of the present invention.

FIG. 6 is an enlarged view of an embodiment of the main sealing in the pouch sealing of the pouch-type secondary battery in an embodiment of the present invention.

FIG. 7 is a diagram showing the effect of an embodiment of the degassing sealing in the pouch sealing of the pouch-type secondary battery in an embodiment of the present invention.

FIG. 8 is a perspective view showing an embodiment form of a main sealing tool used for main sealing in the pouch sealing of the pouch-type secondary battery in an embodiment of the present invention.

FIG. 9 is a diagram showing a photograph of the actual shape of the main sealing tool used for the main sealing in the pouch sealing of the pouch-type secondary battery in an embodiment of the present invention and its specification.

### DETAILED DESCRIPTION

Hereinafter, an embodiment of the present invention will be described in detail based on the accompanying drawings so that a person having ordinary knowledge in the technical field to which the present invention belongs can easily carry it out. This invention may, however, be embodied in many different forms and is not limited to the embodiments set forth herein.

When a certain component is referred to as being “connected to, provided in or installed in” another component, it may be directly connected to or installed in the other component, but it should be understood that other configurations may be present between them. On the other hand, when a certain component is referred to as being “directly connected to, provided in, or installed in” another component, it should be understood that there are no other components between them.

An embodiment of the present invention will be described below.

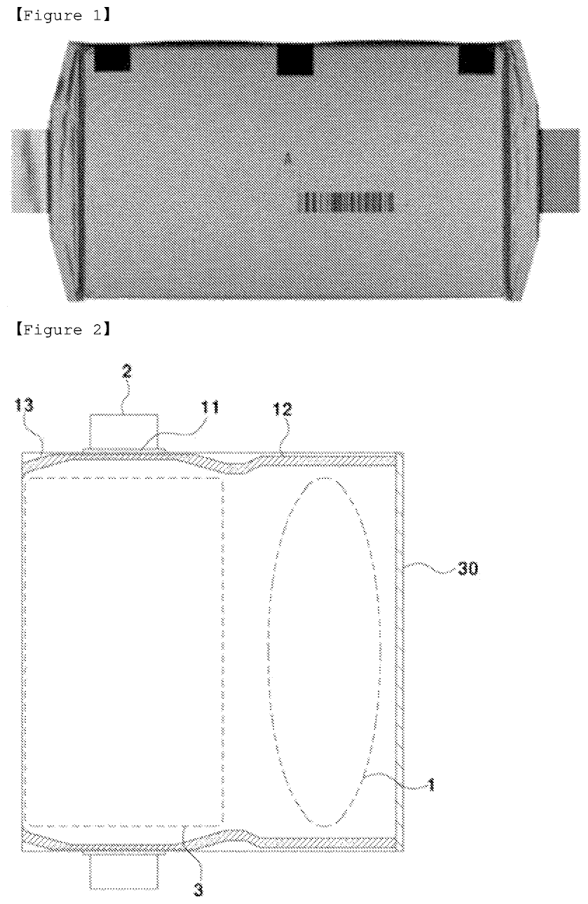

In the related art, a pouch-type secondary battery having a structure as shown in FIG. 1 is manufactured to reduce the dead space due to the sealing portion on the side where the electrode terminals are located. In order to manufacture the pouch-type secondary battery as described above, sealing in the form shown in FIG. 2 is performed when degassing sealing.

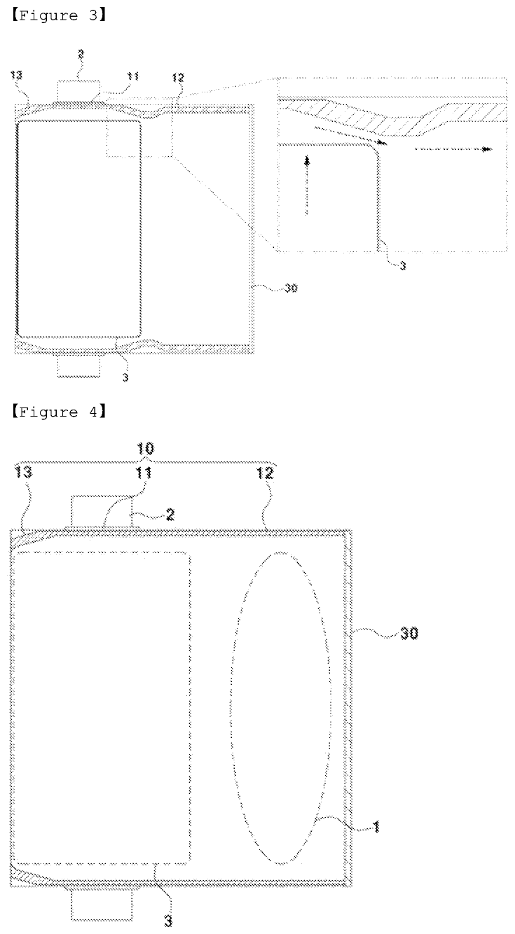

However, when such a sealing structure is applied, as shown in FIG. 3, the space between the edge of the electrode assembly on the side where the electrode terminals are located and the sealing portion is formed to be narrow (part (2)). Therefore, after the formation process, when the gas existing in the electrode assembly housing portion escapes from the narrow space in the cell press process, a large pressure is formed, and the inclined sealing portion on the dead space side is damaged by such pressure. As a result, the insulating properties of the sealing portion also deteriorate.

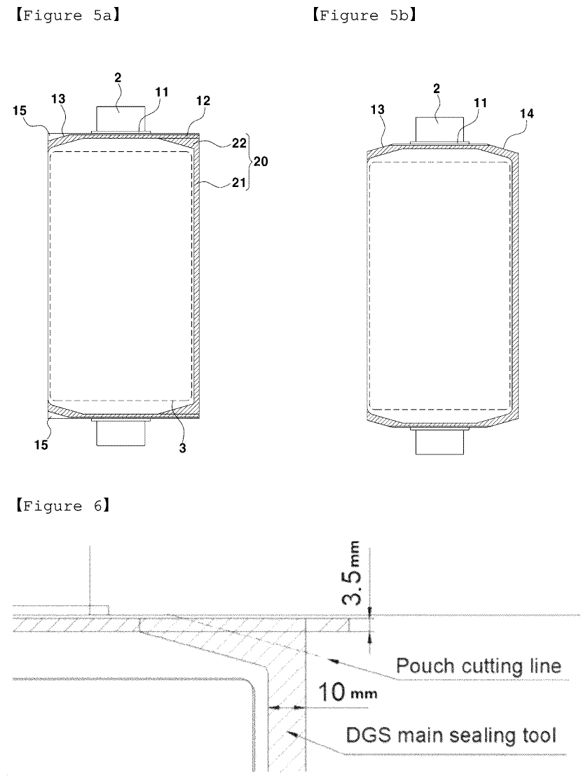

FIG. 4 is a diagram showing an embodiment of a degassing sealing in the pouch sealing of the pouch-type secondary battery in an embodiment of the present invention, and FIG. 5 is a diagram showing an embodiment of the main sealing in the pouch sealing of the pouch-type secondary battery in an embodiment of the present invention.

The pouch sealing method of the pouch-type secondary battery in an embodiment of the present invention includes:
(a) a step of performing degassing sealing including a dead space 1;
(b) a step of performing a formation process;
(c) a step of performing a degassing process; and
(d) a step of performing main sealing.

As shown in FIG. 4, the degassing sealing is formed such that a full-width sealing portion 10 including an electrode terminal sealing portion 11 includes a horizontal sealing portion 12 formed from the electrode terminal 2 to a distal end of the dead space 1 in a horizontal direction, and an inclined sealing portion 13 in the direction opposite to the horizontal sealing portion 12, wherein the inclined sealing portion 13 includes an inclined portion inclined toward a battery electrode assembly housing portion 3 between the electrode terminal 1 and a distal end.

As shown in FIGS. 5a & 5b, the main sealing includes performance of a parallel sealing 21 which is parallel to a full-length direction of the electrode assembly housing portion 3, and performance of a correction 22, such that the horizontal sealing portion 12 of the full-width sealing portion is symmetrical with the inclined sealing portion 13 of the opposite side.

As shown in FIG. 5(b), the pouch sealing method for a pouch-type secondary battery according to an embodiment of the present invention may further include a process of forming an inclined portion (chamfering step) by symmetrically removing an outer horizontal sealing portion 12 of the corrected portion 22 to the inclined sealing portion 13 after main sealing. At this time, the dead space 1 can be removed by cutting before and after the main sealing.

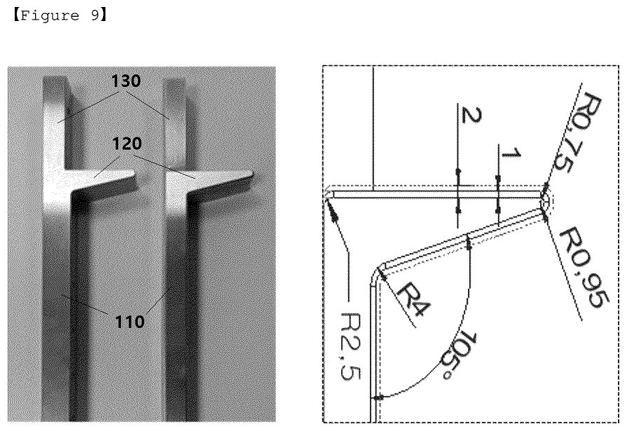

In an embodiment of the invention, the main sealing can be performed using the main sealing tool 100 shown in FIGS. 8 and 9.

As shown in FIGS. 8 and 9, the main sealing tool 100 may include a linear pressing portion 110 that performs a parallel sealing parallel to a full-length direction of the electrode assembly housing portion 3 (forming the parallel sealing portion 21), and an inclined pressing portion 120 coupled to one end of the linear pressing portion with an internal angle in a range exceeding 90 degrees to 150 degrees, more preferably 100 degrees to 130 degrees.

The inclined pressing portion 120 is used to correct the horizontal sealing portion 12 of the full-width sealing portion 10 to be symmetrical with the inclined sealing portion 13 of the opposite direction.

An inclined pressing portion 120′ may be further coupled to the other end of the linear pressing portion 110, wherein the inclined pressing portion 120′ is coupled in the same direction and at the same internal angle with the inclined pressing portion 120.

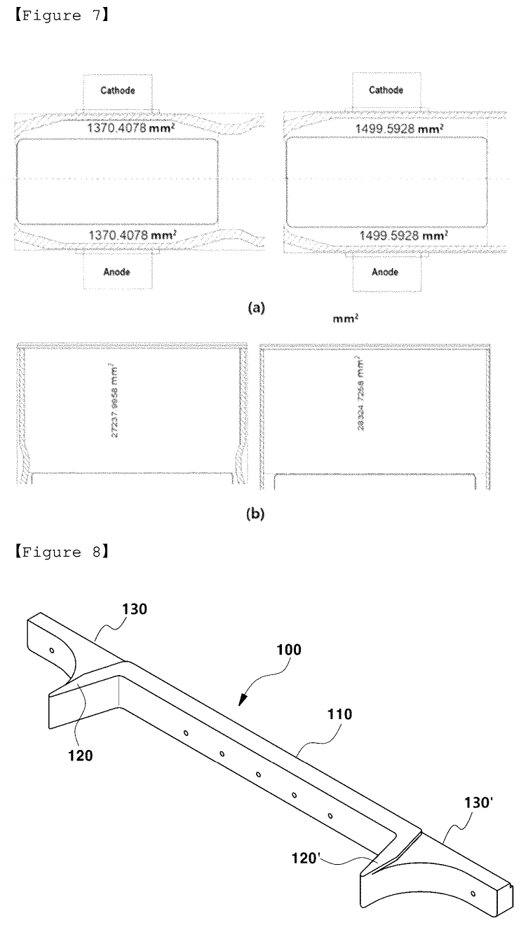

In an embodiment of the present invention, in the pouch sealing method for the pouch-type secondary battery, when the main sealing performs the correction 22 such that the horizontal sealing portion 12 of the full-width sealing portion 10 is symmetrical with the inclined sealing portion 13 of the opposite direction, as shown in FIG. 6, the inclined pressing portion 120 of the main sealing tool 100 may be applied only to the remaining inclined portion, except for the horizontal sealing portion 12, for degassing sealing or may be applied to the horizontal sealing portion 12 and the inclined portion at the same time.

In an embodiment of the present invention, in the pouch-type secondary battery, the electrode terminal 2 may be formed only in one direction, or may exist in both directions symmetrical with each other. When the electrode terminals exist in both directions symmetrical with each other, both sides of the full-width sealing portion 10 may be formed in the same form and in the same manner.

In an embodiment of the present invention, the degassing sealing may include sealing the distal end of the full-width direction of the dead space 1 in a straight line to the full-length direction to form a full-length direction degassing sealing portion (30 of FIG. 4).

In an embodiment of the present invention, the degassing sealing may include sealing the distal end of the electrode assembly housing portion (3) in the full-width direction (direction opposite to the dead space) in a straight line to the full-length direction. If the distal end of the electrode assembly housing portion (3) in the full-width direction is in the state of being sealed by the pouch case structure (see FIG. 4), it may not be included in the sealing.

According to the pouch sealing method for a pouch-type secondary battery in an embodiment of the present invention, as shown in FIG. 7, a sufficient flow path is formed through which the gas can escape from the electrode assembly housing portion 3 to the dead space 1 in the degassing process. Moreover, according to such a degassing sealing form, there is provided an effect in which, as shown in FIG. 7(a), the cross-sectional area of the space where the electrode assembly housing portion 3 is located increases by 9.43%, and as shown in FIG. 7(b), the cross-sectional area of the dead space 1 also increases by 3.99%.

In an embodiment of the present invention, the degassing sealing of the step (a) is a step of sealing a dead space to perform a degassing process for removing gas generated after the formation process, and can be performed by a method known in the art, except for formation of the horizontal sealing portion 12 as described above. In addition, the formation process of step (b) and the degassing process of step (c) can be performed by a method known in the art.

Even in the case of the main sealing in the above step (d), it can be performed by the method known in this field, except for the process of forming the corrected inclined sealing portion 14 of FIGS. 5(a) & 5(b).

A formation process in an embodiment of the present invention means a process that is also called an activation process in this field. Due to the characteristics of the secondary battery, the activation process for the activation of an anode active material and the formation of a stable Solid Electrolyte Interface (SEI) film at a cathode needs to precede at the initial cycle. However, a large amount of gas is generated by the activation process and exists inside the exterior material. Such gas needs to be removed through an opening or a cut formed in the gas pocket (dead space) of the exterior material, and the exterior material is heat-welded and sealed to form the final product shape (main sealing). The process of discharging the gas inside the secondary battery in this way is called a degassing process.

FIG. 8 is a perspective view showing an embodiment of the main sealing tool 100 used for the main sealing in the pouch sealing of the pouch-type secondary battery in an embodiment of the present invention, and FIG. 9 is a diagram showing a photograph of the actual form of the main sealing tool, and its specification.

The main sealing tool (100) in an embodiment of the present invention has a linear pressing portion 110 that performs a parallel sealing (20 of FIGS. 5a & 5b) parallel to the electrode assembly housing portion in the full-length direction, and an inclined pressing portion 120 coupled to one end of the linear pressing portion (110) with an internal angle in a range exceeding 90 degrees to 150 degrees, preferably 100 to 130 degrees, and the inclined pressing portion 120 performs a function of correcting the horizontal sealing portion 12 of the full-width sealing portion 10 to be symmetrical with the inclined sealing portion 13 of an opposite direction.

In an embodiment of the present invention, although the form of the linear pressing portion 110 is not particularly limited as long as it is a form capable of performing the parallel sealing 21 (formation of the parallel sealing portion 20), it may have a quadrangular prism shape.

In an embodiment of the present invention, an inclined pressing portion 120′ may be further coupled to the other end of the linear pressing portion 110 in the same direction and at the same internal angle with the inclined pressing portion 120.

In an embodiment of the present invention, although the inclined pressing portion 120 is not particularly limited as long as it has a form capable of forming the corrected inclined sealing portion 14 as shown in FIG. 5(b), as shown in FIGS. 8 and 9, it may be in the form similar to a triangular prism, and specifically in the form of a right-angled triangular prism. However, since the corrected inclined sealing portion 14 can be formed even in the case of a quadrangular prism shape, the shape is not particularly limited.

In an embodiment of the present invention, the main sealing tool 100 may further include an extension 130 in which the linear pressing portion 110 extends further outward from the inclined pressing portion 120, as shown in FIGS. 8 and 9. The extension 130 can perform the function of coupling the main sealing tool 100 to the pressure device.

Although the present invention was described in relation with the aforementioned preferable embodiments, various modifications and variations may be made without departing from the spirit and scope of the invention. Accordingly, the appended claims shall include such modifications or variations insofar as they fall within the spirit of the present invention.

### DESCRIPTION OF SYMBOLS

1: Dead space
2: Electrode terminal
3. Electrode assembly housing portion
10: Full-width sealing portion
11: Electrode terminal sealing portion
12: Horizontal sealing portion
13: Inclined sealing portion
14: Corrected inclined sealing portion
15: Horizontal portion
20: Main sealing portion
21: Parallel sealing portion
22: Corrected portion
30: Full-length direction degassing sealing portion
100: Main sealing tool
110: Linear pressing portion
120, 120′: Inclined pressing portion
130, 130′: Extension

1. A pouch scaling method for a pouch-type secondary battery, the method comprising:
(a) performing a degassing sealing of a pouch, wherein the pouch includes a dead space, the dead space being a region of the pouch not configured to receive an electrode assembly;
(b) performing a formation process;
(c) performing a degassing process; and
(d) performing a main scaling,
wherein the degassing scaling is configured to form a full-width scaling portion, the full width sealing portion including an electrode terminal scaling portion, a horizontal scaling portion, and an inclined scaling portion, wherein the full width scaling portion is disposed along an edge of the pouch extending transverse to a longitudinal dimension of the electrode assembly;
wherein the inclined sealing portion includes an inclined portion configured to incline toward an electrode assembly housing portion, wherein the inclined sealing portion is disposed between a first electrode terminal and a first distal end, the first distal end being disposed on a side of the pouch opposite to the dead space, and
wherein the main scaling forms a parallel scaling extending parallel to a longitudinal dimension of the electrode assembly housing portion, wherein the parallel scaling is disposed between the electrode housing portion and the dead space, and wherein the main scaling further includes correcting the horizontal sealing portion of the full-width scaling portion, so as to modify the horizontal sealing portion to be symmetrical with the inclined scaling portion across a central longitudinal axis of the pouch.

2. The pouch scaling method according to claim 1, wherein the correcting of the horizontal sealing portion includes removing a portion of the horizontal sealing portion, so as to form a corrected inclined scaling portion that is symmetrical with the inclined sealing portion across the central longitudinal axis of the pouch.

3. The pouch scaling method according to claim 1, wherein the first electrode terminal is disposed on a same side of the pouch as a second electrode terminal.

4. The pouch scaling method according to claim 1, wherein the degassing sealing includes sealing a full length direction sealing portion, wherein the full length direction scaling portion extends in a longitudinal dimension along a second distal end, wherein the dead space is disposed between the electrode housing portion and the second distal end.

5. The pouch scaling method according to claim 1, wherein the degassing sealing includes sealing the first distal end being disposed on a side of the pouch opposite to the dead space along a longitudinal dimension of the electrode assembly housing portion along; or does not include the scaling of the first distal end, in case that the first distal end is in the state of being sealed by the pouch case structure.

6. A main sealing tool used for the main sealing according to claim 1, comprising:
a linear pressing portion configured to perform the parallel scaling; and
a first inclined pressing portion coupled to a first end of the linear pressing portion, wherein the first inclined pressing portion has a first internal angle between more than 90 degrees to 150 degrees, the first internal angle being an interior angle disposed between the first inclined pressing portion and the first end of the linear pressing portion,
wherein the first inclined pressing portion is configured to perform the step of correcting the horizontal sealing portion of the full-width scaling portion, so as to form a corrected inclined sealing portion symmetrical with the inclined sealing portion across the central longitudinal axis of the pouch.

7. The main sealing tool according to claim 6, wherein a second inclined pressing portion is coupled to a second end of the linear pressing portion disposed opposite to the first inclined pressing portion, wherein the second inclined pressing portion has a second internal angle between more than 90 degrees to 150 degrees, the second internal angle being an interior angle disposed between the second inclined pressing portion and the second end of the linear pressing portion.

8. The main sealing tool according to claim 6, wherein the first inclined pressing portion has a shape of a triangular prism or a quadrangular prism.

9. The main sealing tool according to claim 6, wherein the main sealing tool further comprises an extension extending from the first end of the linear pressing portion beyond the first inclined pressing portion.

10. The main sealing tool according to claim 7, wherein the second inclined pressing portion has a shape of a triangular prism or a quadrangular prism.

11. The main sealing tool according to claim 7, wherein the main sealing tool further comprises an extension extending from the second end of the linear pressing portion beyond the second inclined pressing portion.

12. The pouch sealing method according to claim 1, wherein the first electrode terminal is symmetrically disposed on an opposing side of the pouch as the second electrode terminal.
